(19) United States
(12) Patent Application Publication
(10) Pub. No.: US 2026/0039535 A1
(43) Pub. Date: Feb. 5, 2026

(54) OPTIMIZED NETWORK PROBING AGENT DEPLOYMENT AND TEST SCHEDULING

(71) Applicant: Cisco Technology, Inc., San Jose, CA (US)

(72) Inventors: Yannick Weibel, Cugy (CH); Andrea Di Pietro, Parasols (FR); Federico Lovison, Fontanelle (IT); Sukrit Dasgupta, Norfolk, MA (US)

(73) Assignee: Cisco Technology, Inc., San Jose, CA (US)

(21) Appl. No.: 18/790,077

(22) Filed: Jul. 31, 2024

(51) Int. Cl. H04L 41/046; H04L 41/0806; H04L 41/12; H04L 43/10; H04L 47/129

(52) U.S. Cl. CPC H04L 41/046; H04L 41/0806; H04L 41/12; H04L 43/10; H04L 47/129

(57) ABSTRACT

In one implementation, a device obtains node information regarding a plurality of nodes in a computer network. The device identifies a topology of the computer network. The device determines an optimal agent deployment plan for probing agents in the computer network based on the node information and the topology of the computer network. The device causes probing agents to be deployed to a selected set of nodes from the plurality of nodes in accordance with the optimal agent deployment plan.

### TECHNICAL FIELD

The present disclosure relates generally to computer systems, and, more particularly, to optimized network probing agent deployment and test scheduling.

### BACKGROUND

Traditionally, path probing has allowed network administrators and route selection mechanisms to assess the performance of the various network paths that are available to a given destination, such as the loss, latency, or jitter along a given path. To do so, path probing entails sending probe packets along the target paths, to record information such as whether the packet reached its destination, how long it took for the packet to traverse the path and/or each hop along the path, etc.

Currently, the best practice methodology has been to deploy path probing agents to as many nodes as possible in the network, in an attempt to maximize the coverage of their tests. In many cases, this leads to excess resource consumption by the probing mechanism, as many probing agents will end up probing the same paths or path segments in the network. In addition, some nodes may lack the local resources to execute their probing agents properly, such as due to having high traffic loads.

### BRIEF DESCRIPTION OF THE DRA WINGS

The implementations herein may be better understood by referring to the following description in conjunction with the accompanying drawings in which like reference numerals indicate identically or functionally similar elements, of which:

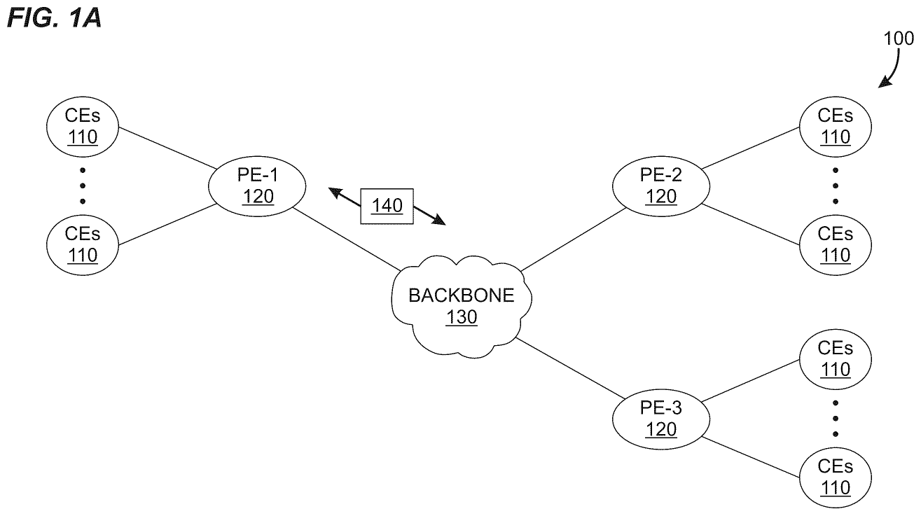

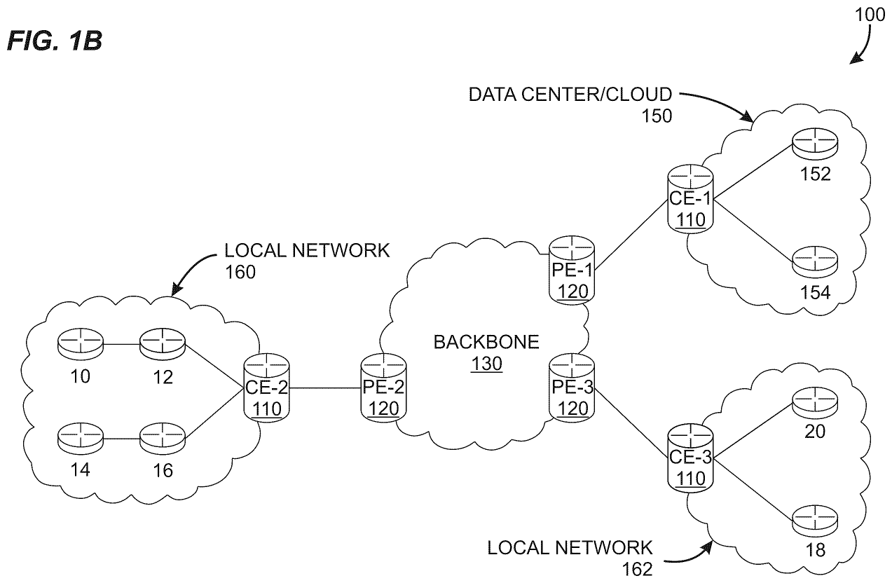

FIGS. 1A-1B illustrate an example communication network;

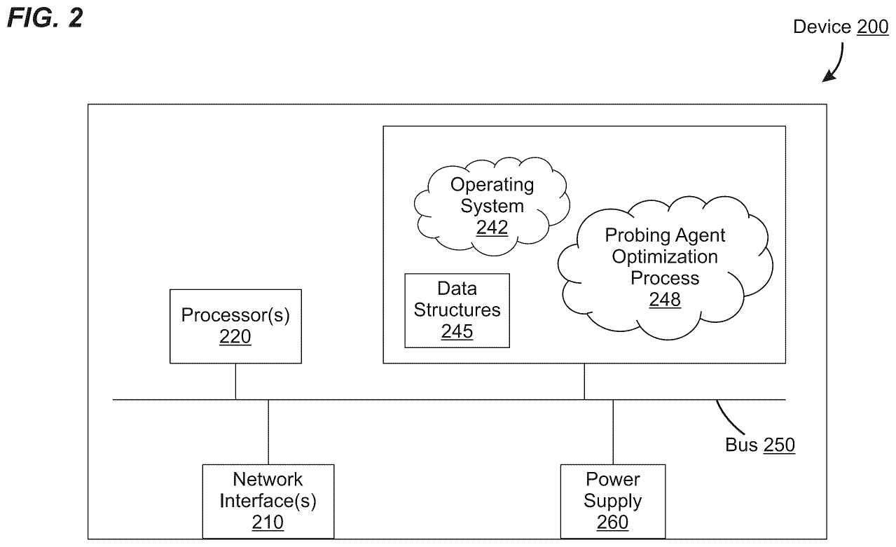

FIG. 2 illustrates an example network device/node;

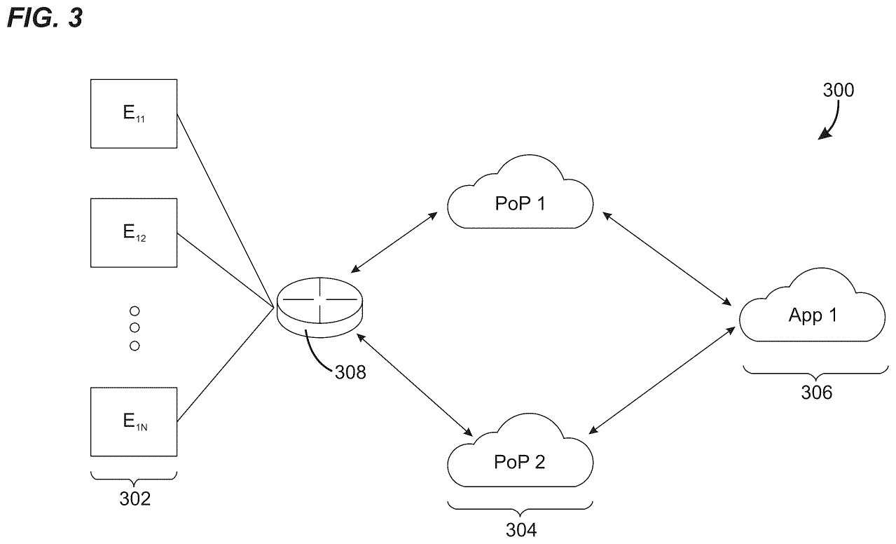

FIG. 3 illustrates an example of an edge router connecting to a cloud-hosted application via multiple points-of-presence (PoPs);

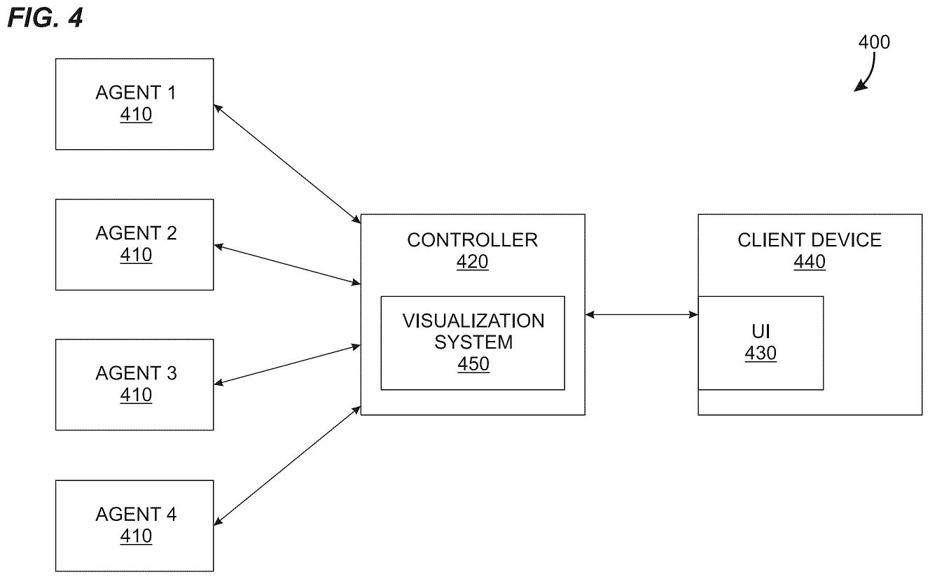

FIG. 4 illustrates an example architecture for a network observability intelligence platform;

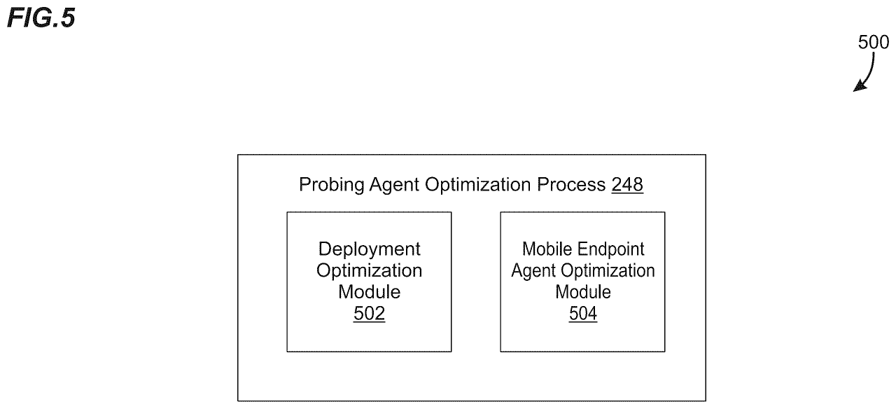

FIG. 5 illustrates an example architecture for a probing agent optimization process;

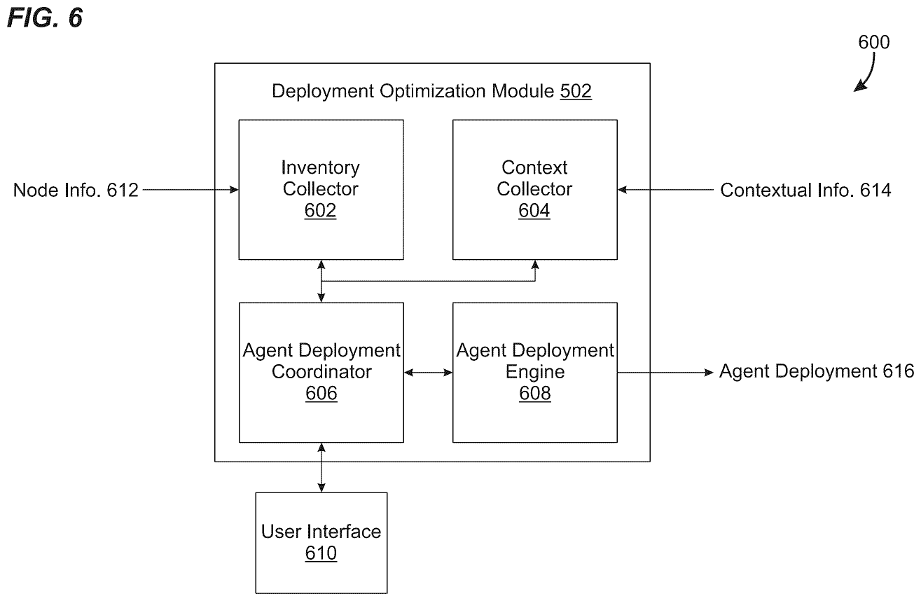

FIG. 6 illustrates an example architecture for optimizing the deployment of probing agents in a network;

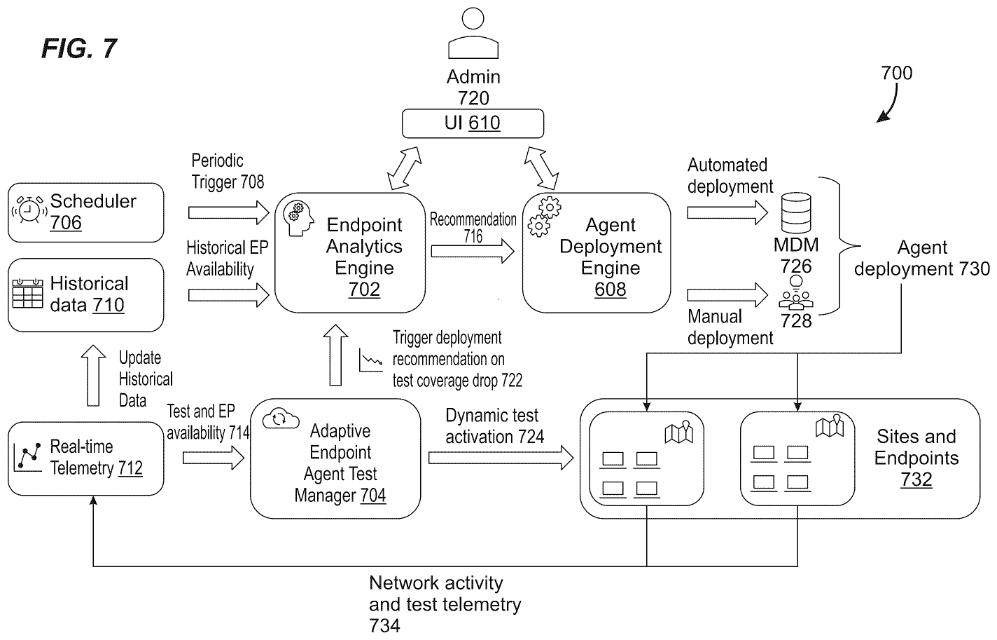

FIG. 7 illustrates an example architecture for deploying probing agents to mobile nodes;

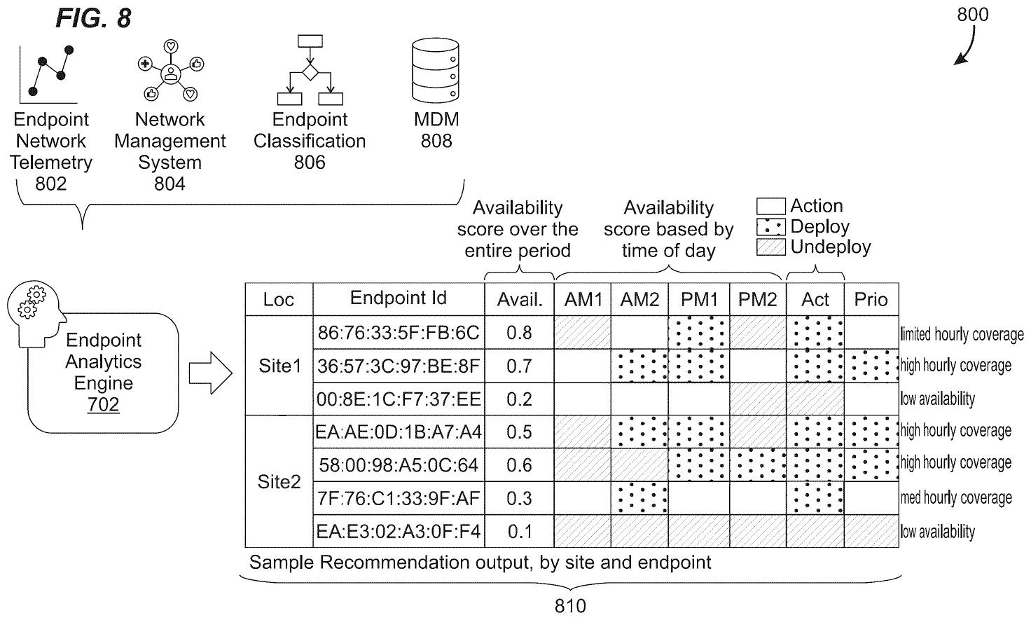

FIG. 8 illustrates an example of the optimized selection of mobile nodes to perform path probing; and

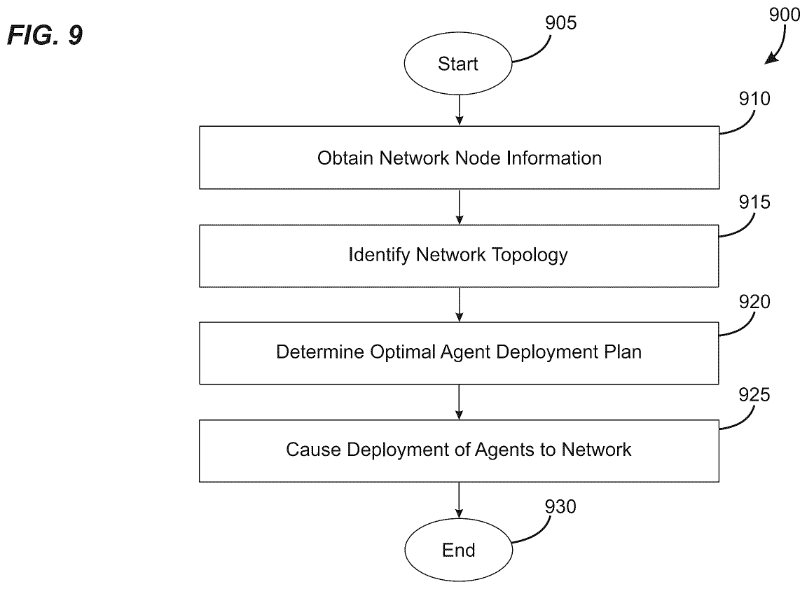

FIG. 9 illustrates an example of a simplified procedure to determine an optimal probing agent deployment plan.

### DESCRIPTION OF EXAMPLE EMBODIMENTS

### Overview

According to one or more implementations of the disclosure, a device obtains node information regarding a plurality of nodes in a computer network. The device identifies a topology of the computer network. The device determines an optimal agent deployment plan for probing agents in the computer network based on the node information and the topology of the computer network. The device causes probing agents to be deployed to a selected set of nodes from the plurality of nodes in accordance with the optimal agent deployment plan.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).
Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of computer network 100 in greater detail, according to various embodiments. As shown, network backbone 130 may provide connectivity between devices located in different geographical areas and/or different types of local networks. For example, computer network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a probing agent optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, probing agent optimization process 248 may also include computer executable instructions that, when executed by processor(s) 220, cause device 200 to perform the techniques described herein. To do so, in some embodiments, probing agent optimization process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, probing agent optimization process 248 may employ one or more supervised, unsupervised, or semi-supervised machine learning models. Generally, supervised learning entails the use of a training set of data, as noted above, that is used to train the model to apply labels to the input data. For example, the training data may include sample telemetry and/or path performance data that has been labeled as being indicative of a path performance level. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that probing agent optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further embodiments, probing agent optimization process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

FIG. 3 illustrates an example 300 of an edge router 308 accessing a cloud-hosted application or service 306. As shown, assume that there are n-number of endpoints 302 at a particular location for which edge router 308 provides external connectivity. An online application or service provider may maintain any number of points-of-presence (PoPs), such as PoPs 304, to which edge router 308 may connect. Accordingly, edge router 310 may access a cloud-hosted application or service 306, such as a SaaS application, via a first PoP among PoPs 304, a second PoP among PoPs 304, etc.

However, the network performance when accessing the cloud-hosted application or service 306 via PoPs 304 is not guaranteed. Indeed, ensuring that traffic SLAs are met may require adjustments:
To meet SLAs, exceptions might be required for traffic that should not be sent through the gateway but directly sent via Direct Internet Access (DIA) locally, in case the gateway is not able to provide a good enough performance for a specific kind of traffic, which highly depends on Peering between the Online application or service provider Gateway PoP and SaaS provider or intermediate Autonomous Systems (AS). For instance, it is sometimes recommended to send out VoIP traffic directly DIA to achieve better performance. However, this defeats the purpose of delivering WAN and security directly in the cloud while relying only on a very simple unique tunnel from all locations.
Selection of the “closest PoP” is usually based on either geo-location, AnyCast (e.g., for secure web gateways relying on HTTPS proxies), probing results (e.g., selecting the PoP with the lowest latency), or by fixing a static PoP location (e.g., as is usually done when setting up fixed IPsec tunnels). However, online application or service providers tend to have rather dense sets of PoPs to which a location can connect. Thus, the closest PoP is not always the best one to use, in terms of providing the best possible application experience. In particular, a PoP might be struggling at certain times of the day to satisfy the SLA of the application traffic, while other nearby PoPs might not.
The performance of a given PoP can also vary between applications. Indeed, performance can be influenced by any or all of the following factors:
   Edge to PoP.
   PoP load.
   PoP to PoP, if traffic is sent through a backbone.
   PoP to SaaS. Different PoPs might have different types of inter-connect or peering with SaaS services and might end up going to different SaaS physical endpoints, even if the SaaS exposes a single logical endpoint.

As discussed with respect to illustrative FIG. 4 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 4 is a block diagram of an example observability intelligence platform 400 that can implement one or more aspects of the techniques herein (e.g., through execution of probing agent optimization process 248). The observability intelligence platform is a system that monitors and collects metrics of performance data for a network and/or application environment being monitored. At the simplest structure, the observability intelligence platform includes agents 410 (e.g., one or more agents) and one or more servers and/or controllers, such as the controller 420. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 420 (or controllers) as directed. Note that while FIG. 4 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents 410 may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page, i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 420 is the central processing and administration server for the observability intelligence platform. The controller 420 may serve a browser-based user interface (UI), which may be referred to as an interface 430 that is the primary interface for monitoring, analyzing, and troubleshooting the monitored environment. Specifically, the controller 420 can receive data from agents 410 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 430. The interface 430 may be viewed as a web-based interface viewable by a client device 440. In some implementations, a client device 440 can directly communicate with controller 420 to view an interface for monitoring data. The controller 420 can include a visualization system 450 for displaying the reports and dashboards related to the disclosed technology. In some implementations, the visualization system 450 can be implemented in a separate machine (e.g., a server) different from the one hosting the controller 420.

Notably, in an illustrative Software as a Service (SaaS) implementation, an instance of controller 420 may be hosted remotely by a provider of the observability intelligence platform 400. In an illustrative on-premises (On-Prem) implementation, an instance of controller 420 may be installed locally and self-administered.

The controllers 420 receive data from different agents, such as the agents 410 (e.g., Agents 1-4) deployed to monitor networks, applications, databases and database servers, servers, and end user clients for the monitored environment. Any of the agents 410 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (e.g., an application instance) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

As noted above, active network monitoring requires the deployment of agents on network devices or endpoint devices. Determining where to deploy agents is complex as it has both hardware and software requirements and needs to be done in such a way that it maximizes the visibility these agents will provide on the network. Currently, the best practice methodology has been to deploy agents to as many network devices and endpoints as determined by the network operator, in an attempt to maximize the coverage of their tests. This approach, though, is often sub-optimal as it disregards the resource consumption associated with path probing.

However, optimizing the deployment of probing agents in a network is not a simple task, as computer networks are often highly dynamic environments. Indeed, consider the case of a network with wireless endpoints. In such a case, endpoints may appear and disappear on the network over time, utilize different network paths or access points, exhibit different hardware or software configurations, and the like.

### Optimized Network Probing Agent Deployment and Test Scheduling

The techniques herein provide for the deployment of synthetic probing agents on network devices that may maximize their coverage while still minimizing the number of deployments needed across the network. Doing so may minimize the number of duplicate probes being generated for the same information and at the same time prevent unnecessary license entitlements being used up get the same information. Further aspects of the techniques herein allow for the optimization to be extended to wireless networks as well, where wireless endpoints or other nodes may appear or disappear at different locations in the network over time.

Illustratively, the techniques described herein may be performed by hardware, software, and/or firmware, such as in accordance with probing agent optimization process 248, which may include computer executable instructions executed by the processor 220 (or independent processor of interfaces 210) to perform functions relating to the techniques described herein.

Specifically, according to various embodiments, a device obtains node information regarding a plurality of nodes in a computer network. The device identifies a topology of the computer network. The device determines an optimal agent deployment plan for probing agents in the computer network based on the node information and the topology of the computer network. The device causes probing agents to be deployed to a selected set of nodes from the plurality of nodes in accordance with the optimal agent deployment plan.

Operationally, FIG. 5 illustrates an example architecture for a probing agent optimization process. As shown, probing agent optimization process 248 may include any or all of the following components: a deployment optimization module 502 and/or a mobile endpoint agent optimization module 504. As would be appreciated, the functionalities of these components may be combined or omitted. In addition, these components may be executed in a device or in a distributed manner, in which case the combination of executing devices can be viewed as their own singular device for purposes of executing probing agent optimization process 248.

In general, deployment optimization module 502 may be responsible for determining the optimal agent deployment plan for a given network and deploy probing agents to nodes in that network in accordance with that plan. Mobile endpoint agent optimization module 504 represents a potential add-on module working in conjunction with deployment optimization module 502, or incorporated therein, to extend this optimal deployment planning to network having mobile endpoints.

FIG. 6 illustrates an example architecture 600 for optimizing the deployment of probing agents in a network, in various implementations, such as to implement deployment optimization module 502. As shown, deployment optimization module 502 may include any or all of the following sub-modules: an inventory collector 602, a context collector 604, an agent deployment coordinator 606, and/or an agent deployment engine 608. These sub-components may be combined, omitted, or executed in a distributed manner, as desired.

During execution, inventory collector 602 may be responsible for collecting node information 612 from the network, either on a pull or push basis. To do so, inventory collector 602 may interact with external devices such as network controllers, networking devices, or similar systems (e.g., Catalyst Center, Meraki Dashboard, . . . ), to obtain a list of the available candidate nodes to install a probing agent. For each node, inventory collector 602 may also gather ancillary data such as any or all of the following for a given node:
The device type of the node (e.g., access point, switch, router, etc.)
The hardware model of the node.
The software model of the node

After inventory collector 602 identifies the set of nodes in the network, context collector 604 may then obtain contextual information 614 for each of the nodes in that list. To do so, context collector 604 may obtain contextual information 614 from the network controller and or from a cloud-based telemetry data lake (e.g., the Network Assurance Data Platform from Cisco Systems, Inc. or the like). The goal of this operation is to determine how much coverage the installation of an agent on each network node could provide.

In greater details, context collector 604 may obtain any or all of the following contextual information 614, among other data:
The Layer 2 topology of the network
The physical topology of the network (e.g., the building/site each node is located)
Node-specific telemetry such as the available CPU and memory
Information about the network traffic (e.g., flow level information provided by NetFlow, IPFIX, or the like)
Endpoint information (e.g., which specific endpoint has been observed in which part of the network, along with its classification)

Based on the collected information from inventory collector 602 and/or context collector 604, agent deployment coordinator 606 may determine an optimal probing agent deployment plan for the network, in various implementations. To do so, agent deployment coordinator 606 may first identify those network nodes that do not qualify for agent deployment. For instance, such nodes may be ineligible for any of the following reasons, among others:
Their hardware or software versions are incompatible with agent installation.
Their available resources are not sufficient for supporting active probing.
Etc.

Among the nodes that were not removed from the list, agent deployment coordinator 606 may determine an optimal set based on the information retrieved above, as well as potentially on interactions with an administrator. For instance, agent deployment coordinator 606 may interact with a user interface 610 to allow an administrator to define a set of policies or other criteria with which agent deployment coordinator 606 may determine the optimal set of nodes for agent deployment.

By way of example, the following illustrate some potential policies:
Use the site/building information of the physical topology to make sure that each site/building is covered.
Use the Layer 2 topology to determine the role of each node in the network as part of the deployment plan (e.g., to act as an aggregation node, an access node, a distribution node, etc.). Agent deployment coordinator 606 may then select the role for any given node that would minimize the number of agent deployments (e.g., a distribution switch).
Use topology information to minimize and/or maximize the number of hops from the access router.
Use endpoint location information to prioritize the agent deployment to the compatible network devices that are closer to the most active endpoints and users. This way, even if no agent is deployed on all endpoints, a large part of the networks can still be covered. Recommendations may also span across multiple targets based on application usage, in an automated or semi-automated way (e.g., user input defining critical endpoints and/or applications).
Traffic flow level information can be used for optimal deployments of the agents. For example, all switches may have the ability to generate Netflow records that will be captured by the network controller. Agent deployment coordinator 606 may then assess flow level details captured in the Netflow records and correlate them with the originator switch to determine which switches see the most varied application types as well as the most flows traversing them. Based on this, agent deployment coordinator 606 may select only the top N-number of switches that see the most varied application traffic to host probing agents. This can also be done based on the number of flows seen as well.

In some implementations, a network operator/administrator may tune the selection criteria for agent deployment coordinator 606 via user interface 610, based on the requirements (e.g., maximize coverage vs. minimum agent deployments, etc.

In accordance with the policies/criteria set via user interface 610, agent deployment coordinator 606 may generate an agent deployment recommendation plan. Such a plan may, for instance, take the form of an “impact score” or similar for each node. Agent deployment coordinator 606 may then present the score or other plan to user interface 610, along with the contextual information 614 that has been gathered for each node eligible for deployment (e.g., sorted by priority, etc.).

Either automatically or after approval of the deployment plan via user interface 610, agent deployment engine 608 may then initiate the following, either directly or indirectly (e.g., by sending an instruction to another device or service to perform the action):
Installing the agent on each selected node
Configuring the agent based on a template provided via user interface 610. For instance, agent deployment engine 608 may instruct a deployed agent to conduct testing with respect to particular endpoint or application, according to a specified schedule, etc.

In another implementation, agent deployment coordinator 606 may also provide to user interface 610 the list of nodes which could potentially provide good coverage but had to be left out of the list due to hardware or software incompatibility. The goal of such insight is to point the network operator/administrator to nodes where updates could be performed to further optimize the agent coverage. These insights can be filtered and orders by “cost” (complexity) and “impact score” (coverage improvements) to help the customer to prioritize upgrades, in some instances.

Optionally, agent deployment coordinator 606 may also export the list of actions approved by the user (accept recommendation, add agent manually, etc.) to an optional cloud-based storage location. There, this information can be used to refine and tune the recommendation procedure.

### Optimizing Probing Agent Deployment for Mobile Endpoints

As would be appreciated, probing agents installed on mobile endpoints are very valuable as they provide true end-to-end visibility of the network (for instance including statistics and scenarios that are specific to the wireless networking domain), which cannot be covered using enterprise agents only. However, achieving proper coverage with such agents is complex due to the mobile nature of those devices, which not only means that they are likely to move (e.g., from, to, or within the areas of interest), but their availability is also less predictable than that of enterprise agents.

Accordingly, probing agent optimization process 248 may further be configured to select certain endpoints for deployment of probing agents such that they provide the best testing coverage, based on the analysis of historical data representing the activity of endpoints at each site, as well as how the mobile endpoints roam across, and within the sites, and/or their typical availability patterns (e.g., through execution of mobile endpoint agent optimization module 504). In further aspects, mobile endpoint agent optimization module 504 may also dynamically monitor and coordinate the test distribution and scheduling across endpoint agents, based on the real-time location and availability of all the eligible endpoints.

FIG. 7 illustrates an example architecture 700 for deploying probing agents to mobile nodes. For instance, architecture 700 could be used to implement mobile endpoint agent optimization module 504. As shown, architecture 700 may include an endpoint analytics engine 702, an adaptive endpoint agent test manager 704, and/or a scheduler 706, which may interact with the components of deployment optimization module 502, such as agent deployment engine 608 or the like.

During execution, endpoint analytics engine 702 may determine the availability patterns of eligible endpoints for each location in the network, for instance by building, floor, or even more specific areas as defined by the user. To do so, endpoint analytics engine 702 may collect historical data 710 from the network (e.g., from network managements systems such as Catalyst Center or Meraki), in order to characterize the location behavior of the candidate endpoints. Such information may indicate historical endpoint availability, as well as other information. More specifically, historical data 710 may include, but is not limited to, any or all of the following:
Historical data about the presence of the endpoint node on the network (e.g., over a period of 1 week or 1 month, with a distribution of the availability by day of the week and time of the day), including its roaming history and Wi-Fi connection quality statistics.
Additional connectivity details for the node, such as the SSIDs or VLANs used by each endpoint, in order to understand the coverage across all the different network segments.
Endpoint location data. This can be gathered using various techniques such as network-based (based on the associated AP location or RSSI and FTM-based location-based services for Wi-Fi connected endpoints or switchport for the wired endpoints) or, if available, using global navigation satellite system (GNSS) information.
Classification information regarding the endpoint node such as its operating system or device type, which would allow architecture 700 to determine what endpoints can host an agent, as well as assessing the impact of the agent on each specific endpoint (e.g., testing can be more aggressive on laptops, teleconferencing units, or tablets on fixed installation, but a more power conservative test configuration can be pushed on battery operated devices, such as smartphones).
Endpoint inventory from an endpoint management solution, such as Mobile Device Management (MDM) 726, to identify the devices where the deployment can be fully automated.

Endpoint analytics engine 702 can then use the location data to determine the past and present location of the endpoints, in order to estimate the actual and potential testing coverage for each of the locations of interest. In addition, knowing the roaming history and the most visited location(s) for each endpoint helps to reduce bias towards always-connected devices on very specific, but not critical building locations (e.g., the reception desk) as well as adding a weight or preference factor to each endpoint (e.g., prefer clients having a more stable behavior, as excessive roaming may result in test failures). Similarly, the endpoint classification data can be used to assign a preference/weight to each device, depending on the specific interest of getting coverage from specific classes of endpoints.

Endpoint analytics engine 702 may also interact with a system administrator via user interface 610 to define a list of policies defining the coverage requirements that the endpoint agents will need to fulfill. For instance, such policies may specify any or all of the following constraints:
geographical location, by address or coordinates
location description
priority level
hours of operation (e.g., coverage may be relevant only during working hours)
applications of interest
preferred device type for agent deployment (laptops, mobile devices etc.)
minimum and desired tests per time unit (e.g., number of tests per hour)
maximum number of endpoint agents to be deployed (this can have both scale and cost impacts)

The location details can either be manually generated by the user or can be retrieved via an integration with external network monitoring and analytics engines, in various implementations. Based on such user defined policies and historical data 710, endpoint analytics engine 702 may generate an optimal agent deployment plan recommendation 716. Endpoint analytics engine 702 may generate recommendation 716 based on explicit user demand via user interface 610, based on a periodic trigger 708 generated by scheduler 706 (e.g., refreshing recommendation 716 daily, weekly, etc.), or even in response to a trigger 722 from adaptive endpoint agent test manager 704 based on certain types of events occurring in the network (e.g., detection of an anomalous variation of the number of endpoints connected at given location(s) or a drop in testing coverage for an extended period).

In various implementations, endpoint analytics engine 702 may generate recommendation 716 in conjunction with agent deployment coordinator 606 in FIG. 6, to form a comprehensive agent deployment plan across endpoint nodes and networking nodes (e.g., edge routers, switches, etc.). To this end, either or both modules may leverage machine learning, to devise an optimal agent deployment plan.

In general, recommendation 716 may include a list of endpoint nodes, indexed by their identifiers (e.g., the MAC address, the serial number, or other custom identifiers) along with details such as:
recommendation: e.g., install or remove the agent
covered location(s)
etc.

The removal operation is used in order to re-balance the agent distribution considering the deployment constraints, as well as keeping the agent set relevant when new endpoints are added to the network and other ones are decommissioned. Also, a behavior change could be detected in historical data 710 showing that the endpoint is no longer ideal for monitoring (e.g., the owner could stop going to a particular office).

Once the recommendation results are available (and potentially approved via user interface 610), agent deployment engine 608 may implement the deployment plan such as by automatically deploying agents to the selected endpoints via MDM 726. In other cases, agent deployment engine 608 may initiate manual installation of the agents, such as by contacting users 728 to install the agents on the selected endpoint nodes. Regardless of how agent deployment 730 is performed with respect to sites and endpoints 732, the end result is that the endpoint nodes are then able to begin path probing using their installed agents.

The operational outcome may depend on the specific status and management of each endpoint. For instance, the installation or removal of an agent on an endpoint managed via MDM 726 can be fully automated, otherwise agent deployment engine 608 can produce the installation instructions to be distributed to the personnel in charge of the endpoint management (e.g., the end user or the IT helpdesk), sharing instructions and download links, taking into account the specific endpoint type, ownership and location.

FIG. 8 illustrates an example 800 of the optimized selection of mobile nodes to perform path probing, in greater detail. As shown, endpoint analytics engine 702 may leverage information from various sources such as endpoint network telemetry 802, a network management system 804, an endpoint classification system 806, an MDM 808, or the like, to generate a recommended agent deployment plan 810. Here, plan 810 may take into account the different sites, the endpoints available at those sites, when the endpoints are available, and the like. In addition, plan 810 may specify when an agent should be deployed, undeployed, deactivated, or the like, at any given time, given the information available to endpoint analytics engine 702.

Referring again to FIG. 7, in various implementations, adaptive endpoint agent test manager 704 may be responsible for optimizing when and how the deployed agents to endpoints 732 conduct their path tests. For instance, adaptive endpoint agent test manager 704 may attempt to ensure the optimal number of tests by time unit associated to a given location, by performing real-time monitoring of the actual test activity. To do so, adaptive endpoint agent test manager 704 may collect network activity and test telemetry 734 as real-time telemetry 712 and, in turn, send dynamic test activation instructions 724 to selected agents in sites and endpoints 732.

The primary goal of adaptive endpoint agent test manager 704 is to ensure sufficient testing coverage at any point in time, but may also seek to improve the overall testing cost and privacy impact of testing when an endpoint node is no longer connecting from a location of interest.

Consider an enterprise environment where employees are provided with company laptops and mobile devices that can be used by the employees while at their home. In such a case, limiting the active testing only when the endpoints are in the office would avoid unneeded testing costs when an endpoint is taken at home, as well as limiting the privacy exposure of the employee's home network details. Adaptive endpoint agent test manager 704 also be used to initiate different test profiles deployed to the agents, depending on the location of the endpoint node, as the testing coverage needs are different when a user in on-site versus working remotely.

Adaptive endpoint agent test manager 704 may gather the same location data as the endpoint analytics engine 702, but instead of consuming historical data 710, adaptive endpoint agent test manager 704 may instead rely on real-time telemetry 712 on which historical data 710 is based. In another implementation, adaptive endpoint agent test manager 704 may also collect information about the current available resources (e.g., CPU, memory, battery, etc.) on each endpoint node.

By using such input, adaptive endpoint agent test manager 704 may assign a number of tests to execute to a subset of the deployment endpoint agents. The goal of such assignment is to:
fulfil the requirements defined by the user
avoid exhausting the endpoint resources (if resource availability data is available)
guarantee the fairness on the testing load distribution
maximize the value of each test executed

Adaptive endpoint agent test manager 704 may also re-compute such test assignment when it detects new endpoints reaching (or leaving) a monitored location, so as to offload the endpoints which were previously guaranteeing the coverage. As an example, consider the case in which a network operator wants to use endpoint agents in order to guarantee the coverage of a specific site. In such a case, endpoint analytics engine 702 may first use the historical data to select a set of endpoints which are likely to be connected on that site. Then, at every given point in time, it may monitor which of those endpoints are actually connected to that site and assign a subset of the required tests to each of them. As more endpoints connect to the site, endpoint analytics engine 702 may recompute the test assignments and repartition the execution of tests among more and more endpoints.

In another implementation, whenever the testing coverage for a given location drops below its minimum testing threshold for an extended period, adaptive endpoint agent test manager 704 may trigger the generation of a new agent deployment recommendation, in order to identify new endpoints that can be deployed to restore the desired testing coverage.

FIG. 9 illustrates an example of a simplified procedure 900 (e.g., a method) to determine an optimal probing agent deployment plan, in accordance with one or more embodiments described herein. For example, a non-generic, specifically configured device (e.g., device 200) may perform procedure 900 by executing stored instructions (e.g., probing agent optimization process 248). The procedure 900 may start at step 905, and continues to step 910, where, as described in greater detail above, the device may obtain node information regarding a plurality of nodes in a computer network. In some implementations, the node information is indicative of resources available at each of the plurality of nodes or traffic loads of each of the plurality of nodes.

At step 915, as detailed above, the device may identify a topology of the computer network. For instance, the device may do so by interfacing with a network controller, path computation engine, or even constructing the topology from the node information. At step 920, the device may determine an optimal agent deployment plan for probing agents in the computer network based on the node information and the topology of the computer network, as described in greater detail above. In some implementations, the device uses a machine learning model to determine the optimal agent deployment plan. In various instances, the optimal agent deployment plan ensures that two or more nodes in the selected set of nodes do not conduct redundant testing of a portion of the computer network. In one implementation, the optimal agent deployment plan seeks to maximize testing coverage by the probing agents and seeks to minimize a count of the probing agents deployed to the computer network. In some cases, the device generates the optimal agent deployment plan according to a policy set via a user interface.

At step 925, as detailed above, the device may cause probing agents to be deployed to a selected set of nodes from the plurality of nodes in accordance with the optimal agent deployment plan. In various implementations, the probing agents are configured to conduct tests in the computer network by sending probe packets via paths in the computer network. In some cases, the selected set of nodes comprise one or more mobile endpoints and the node information comprises a history of locations of the one or more mobile endpoints. In further cases, the selected set of nodes comprise one or more edge routers. In one implementation, the device may cause the probing agents to be deployed in part by configuring the probing agents to probe paths of the computer network at specified times.

Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments for optimizing network probing agent deployment and test scheduling, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
obtaining, by a device, node information regarding a plurality of nodes in a computer network;
identifying, by the device, a topology of the computer network;
determining, by the device, an optimal agent deployment plan for probing agents in the computer network based on the node information and the topology of the computer network; and
causing, by the device, probing agents to be deployed to a selected set of nodes from the plurality of nodes in accordance with the optimal agent deployment plan.

2. The method as in claim 1, wherein the probing agents are configured to conduct tests in the computer network by sending probe packets via paths in the computer network.

3. The method as in claim 1, wherein the device uses a machine learning model to determine the optimal agent deployment plan.

4. The method as in claim 1, wherein the optimal agent deployment plan ensures that two or more nodes in the selected set of nodes do not conduct redundant testing of a portion of the computer network.

5. The method as in claim 1, wherein the selected set of nodes comprise one or more mobile endpoints and the node information comprises a history of locations of the one or more mobile endpoints.

6. The method as in claim 1, wherein the selected set of nodes comprise one or more edge routers.

7. The method as in claim 1, wherein the optimal agent deployment plan seeks to maximize testing coverage by the probing agents and seeks to minimize a count of the probing agents deployed to the computer network.

8. The method as in claim 1, wherein causing the probing agents to be deployed comprises:
configuring the probing agents to probe paths of the computer network at specified times.

9. The method as in claim 1, wherein the device generates the optimal agent deployment plan according to a policy set via a user interface.

10. The method as in claim 1, wherein the node information is indicative of resources available at each of the plurality of nodes or traffic loads of each of the plurality of nodes.

11. An apparatus, comprising:
one or more network interfaces;
a processor coupled to the one or more network interfaces and configured to execute one or more processes; and
a memory configured to store a process that is executable by the processor, the process when executed configured to:
obtain node information regarding a plurality of nodes in a computer network;
identify a topology of the computer network;
determine an optimal agent deployment plan for probing agents in the computer network based on the node information and the topology of the computer network; and
cause probing agents to be deployed to a selected set of nodes from the plurality of nodes in accordance with the optimal agent deployment plan.

12. The apparatus as in claim 11, wherein the probing agents are configured to conduct tests in the computer network by sending probe packets via paths in the computer network.

13. The apparatus as in claim 11, wherein the apparatus uses a machine learning model to determine the optimal agent deployment plan.

14. The apparatus as in claim 11, wherein the optimal agent deployment plan ensures that two or more nodes in the selected set of nodes do not conduct redundant testing of a portion of the computer network.

15. The apparatus as in claim 11, wherein the selected set of nodes comprise one or more mobile endpoints and the node information comprises a history of locations of the one or more mobile endpoints.

16. The apparatus as in claim 11, wherein the selected set of nodes comprise one or more edge routers.

17. The apparatus as in claim 11, wherein the optimal agent deployment plan seeks to maximize testing coverage by the probing agents and seeks to minimize a count of the probing agents deployed to the computer network.

18. The apparatus as in claim 11, wherein the apparatus causes the probing agents to be deployed by:
configuring the probing agents to probe paths of the computer network at specified times.

19. The apparatus as in claim 11, wherein the apparatus generates the optimal agent deployment plan according to a policy set via a user interface.

20. A tangible, non-transitory, computer-readable medium storing program instructions that cause a device to execute a process comprising:
obtaining, by the device, node information regarding a plurality of nodes in a computer network;
identifying, by the device, a topology of the computer network;
determining, by the device, an optimal agent deployment plan for probing agents in the computer network based on the node information and the topology of the computer network; and
causing, by the device, probing agents to be deployed to a selected set of nodes from the plurality of nodes in accordance with the optimal agent deployment plan.
